(19) United States
(12) Patent Application Publication
(10) Pub. No.: US 2023/0331893 A1
(43) Pub. Date: Oct. 19, 2023

(54) SURFACE-COATING FLUID COMPOSITION FOR ABSORBING AND DIFFUSING VOLATILE COMPOUNDS

(71) Applicant: CEVA SANTE ANIMALE, LIBOURNE (FR)

(72) Inventors: Yannick Escudie, Nousty (FR); Patrick Durand, Bergerac (FR); Olivier Guerret, Pern (FR)

(21) Appl. No.: 18/026,566

(22) PCT Filed: Sep. 16, 2021
(86) PCT No.: PCT/FR2021/051589

§ 371 Date: Mar. 15, 2023

(30) Foreign Application Priority Data
Sep. 17, 2020 (FR) FR2009430

(51) Int. Cl. C08F 293/00; C08J 5/24

(52) U.S. Cl. CPC C08F 293/00; C08J 5/24; C08J 2353/00

(57) ABSTRACT

The invention relates to a paint- or ink-type liquid composition which is applied to any substrate and forms a solid surface coating, and which can be loaded with a semiochemical compound and can then gradually diffuse said compound over long periods

Semiochemical substances (pheromones, kairomones, allomones and synomones) are volatile substances increasingly used in many fields, for example, for controlling animal behavior or for regulating insect pest populations.

Furthermore, these semiochemical substances are molecules that are chemically sensitive and more particularly sensitive to oxidation (especially in the presence of UV or free radicals) or to temperatures since they have unsaturated chemical bonds (double or triple bonds), alcohol groups or stretched ether rings. However, the formation of impurities by oxidation processes may have catastrophic effects on the effectiveness of the semiochemicals (an attractant may for example become a repellent, or the pheromone of one insect in particular can transform into the pheromone of another insect).

One of the major problems that arises in order to be able to use these semiochemical substances optimally is the possibility of storing them and releasing them using materials that not only allow the preservation of the purity of the semiochemicals during the manufacture of the device and during the time of use, but also allow a controlled release at sufficient levels over long periods of time. Another problem is to be able to load the materials several times in order to avoid having to manufacture and use a new item each time a usage is desired again.

There are liquid or fluid compositions, of paint type, comprising an active compound such as an insecticide, for example, intended to be applied on substrates, such as walls, for example, in order to allow the diffusion of said compound into the ambient air. However, once the diffusion has ended due to the exhaustion of the compound contained in the coating, it is no longer possible to reproduce the diffusion unless the application of a new layer of composition is repeated, that is another a layer of paint is added containing the active compound to be diffused.

This is cumbersome and expensive as it involves repetitive applications of the paint composition and a superposition of layers on the substrate, which is not desirable on the long term.

The use of polymeric matrices for the release of active substances, especially semiochemical substances, has been known for a long time since it was already mentioned, for example, in the review of Campion (D.G. Campion, Pestic. Sci. 1978, 9, 434-440). Reference is made especially in this publication to the use of rubber (or elastomeric) matrices. However, it is also emphasized that such matrices do not allow for continuous release over time and have a high sensitivity to atmospheric conditions.

Later, other elastomeric matrices were proposed: for example, in 1987, in U.S. Pat. No. 4,703,070. However, these elastomeric matrices require incorporating the active substance before the elastomeric matrix is completely crosslinked. However, because of their specific chemical structures (unsaturated bond, the presence of alcohol functions, etc.) few semiochemical substances can durably withstand either the high temperatures necessary at the end of crosslinking, or the reactive components of the prepolymer. Still, the activity of the semiochemical substances is greatly influenced by a very slight deterioration of the molecule (such as a change of isomerism, for example).

Another thermoplastic matrix for the semiochemical release was the subject of a patent filed in 1996 (U.S. Pat. No. 5,504,142). In this case, the matrix is a copolymer of the PEBAX® type. Pebax® is a thermoplastic elastomer or a plasticizer-free flexible polyamide composed of a regular linear chain of rigid polyamide segments and flexible polyether segments. However, this type of matrix requires the use of a solvent acting as a vector to the active substance in order to penetrate the copolymer matrix. These solvents necessary for the implementation of the method described in this invention are potentially harmful to the environment or may have a negative interaction with animals. The presence of such solvents (derivatives of undecylenic acid with biocidal properties well known to those skilled in the art) is therefore prohibitive fora use of such a matrix for storing and releasing semiochemical substances.

Another large family of copolymer matrices was then proposed based on polyethylene glycol (PEG). In 2005, for example, Brown et al (J. Am. Chem. Soc. 2005, 127, 11238-11239), proposed using a copolymer based on polyethylene glycol (PEG) and a hyperbranched hydrophobic fluoropolymer to store and release an unsaturated terpene alcohol (geraniol). Although it shows large capacities to store this molecule, such a copolymer would lead to greatly reduced release times of the active substance, which is incompatible with the long-lasting release necessary in the use of semiochemicals in agriculture. In 2010, Shakil et al (p228 of the review by M. Kah in Environment International 63 (2014) 224-235) proposed aqueous formulations based on amphiphilic copolymers containing PEG blocks to release insecticides. However, these aqueous formulations have the drawback of not being solid, and the presence of water may induce chemical modifications in the semiochemicals.

The copolymers matrices of ethylene and vinyl acetate have also been tested for delivering bioactive compounds such as food attractants, pesticides, as described in U.S. Pat. No. 5,135,744.

However, the mixture of the copolymer and of the bioactive compound and the final shaping (extrusion) must be carried out at high temperatures (between 80 and 110° C.), which cannot be carried out with most of semiochemical substances, which either cannot withstand these transformation conditions or rapidly evaporate at the outlet of the extruder, making the loading of semiochemical substance in the plastic difficult to control.

Other copolymers have also been proposed, for example in WO2012/095444, which claims the formation of microcapsules composed of several polymers including C1-C24-alkyl esters of acrylic acid. This type of matrix can be used only for semiochemical substances that do not have sensitivity to peroxides that are necessary for the polymerization of the matrix, that is, for a limited number of semiochemical substances. Likewise, patent WO2013156249A1 describes a composition comprising a pesticide and a random copolymer that contains, in polymerized form, acrylic or methacrylic acid (monomer A), a mono poly (C2-6 alkylene alcohol) (meth)acrylate terminated by a C12-C22 alkyl (monomer B), and a C1-C6 alkyl methacrylate (monomer C). However, this type of random copolymer is obtained once again by polymerization with a radical generator (in the examples of this patent, tert.-butylperpivalate) that, as already highlighted, represents a danger of causing common semiochemical substances to deteriorate. For example, it is well known that (E,Z)-7,9 dodecadienylacetate (sexual pheromone of the European grapevine moth) transforms into (E, E)-7,9 dodecadienylacetate, which has no effect on the insect.

Likewise, document EP0338732 describes a matrix for the release and diffusion of active substances such as fragrances and pheromones in the atmosphere. The matrix is permeable to active substances and is formed of a copolymer that may be softened sufficiently at a temperature of between 45° C. and 160° C. to incorporate the substances therein. The matrix is formed of a substantially linear block copolymer that is a reaction product of a polydiorganosiloxane that forms soft segments in said reaction product and a diisocyanate that forms hard segments, said soft segments comprising from 70 to 99% by weight, based on the weight of said copolymer. The problem with such a matrix is that its manufacture involves high temperatures not compatible with pheromones. Furthermore, once the pheromone has been diffused, it is not possible to reload the matrix.

Document WO0150859 also describes a slow-release insect repellent composition comprising an insect repellent, an oleophilic chemical soluble in insect repellent, and a carbohydrate matrix wherein the combination of the insect repellent and oleophilic chemical is entrapped in the matrix such that the repellent is released from the matrix, a fabric substrate containing the composition and a method for preparing the composition. The problem with this type of composition is that the solidification entails a drying step at temperatures incompatible with pheromone compounds that are very sensitive to heat and that will evaporate during this step. In addition, as indicated for other substrates, once the insect repellent compound has been fully diffused, the composition cannot be reloaded.

FR3032972 describes a composition comprising a polymer elastomer phase in the form of an acrylic block copolymer and an odorizing active compound, methods of absorption of the odorous active compound and of release of said odorous active compound for a given period of time. This document also describes objects or articles comprising a polymer elastomer phase in the form of an acrylic block copolymer and an odorous active compound. However, this document does not describe liquid or fluid compositions but compositions obtained by injection molding, extrusion, co-extrusion or extrusion/blow-molding leading to the preparation of profiled parts or elements, blocks, tubes, sheets or even films.

The present invention therefore proposes a novel type of paint- or ink-type liquid composition that is applied to any substrate and forms a solid surface coating—or at least a cohesive one—and that can be loaded with a semiochemical compound and can then gradually diffuse said compound over long periods. Furthermore, once the diffusion of said compound has been completed, the coating can be reloaded with the semiochemical substance by simply having said substance come into contact with the coating. This makes it possible to achieve the objective of adsorption, protection, and controlled release of said semiochemical substance over long periods, and can do so repeatedly.

Thus, the present invention firstly relates to a method for diffusing a semiochemical substance comprising the following steps:
a. providing a solid composition comprising a polymeric resin, an optional filler and an optional pigment,
b. bringing a composition comprising a semiochemical substance into contact with the solid composition,
c. Impregnating the solid composition with the composition comprising the semiochemical substance,
d. Diffusing said semiochemical substance from the solid composition,
e. optionally, repeating steps b to d.

According to one embodiment, the method according to the invention is characterized in that the solid composition comprising a polymeric resin further comprises at least one acrylic block copolymer, said acrylic block copolymer comprising at least one alkyl polymethacrylate block and at least one alkyl polyacrylate block; said copolymer being dispersed and immobilized in the polymeric resin.

Typically, the alkyl is a linear or branched C1-C10 alkyl, in particular C1-C8.

According to a particular embodiment, the method according to the invention is characterized in that step a) is preceded by steps α1) to α3); step α1) comprising providing a liquid composition comprising at least one polymeric resin, at least one solvent, optionally at least one pigment, optionally at least one filler and optionally at least one acrylic block copolymer, said acrylic block copolymer comprising at least one alkyl polymethacrylate block and at least one alkyl polyacrylate block; step α2) comprising applying the liquid composition to a substrate and step α3) comprising evaporating the solvent. Typically, the alkyl is a linear or branched C1-C10 alkyl, in particular C1-C8.

A “filler” is an ingredient that is inert with regard to semiochemical compounds, in general it is a mineral substance of naturally white or slightly colored origin in the form of very fine particles, particles that are practically insoluble in the medium of the composition. The filler is used for example to thicken the composition, to improve its adhesion, give an aesthetic appearance or limit shrinkage once the solvent is evaporated and the composition has solidified. The filler may be selected from the group consisting of talc, carbonates, clays, and mixtures thereof.

The term “polymeric resin” is understood here to mean resins usually used in compositions of the screen printing ink type, for example and may comprise cellulosic resins, vinyl resins or else polyurethane resins, single- or two-component. Cellulosic resins typically comprise nitrocellulose resins of ethylcellulose, acetobutyrate or cellulose acetopropionate and can be combined with other alkyd, polyester, polyurethane or polyamide resins. Vinyl resins typically comprise polyvinyl acetates, polyvinyl chlorides, vinyl acetate/vinyl chloride copolymers or polyvinyl ethers.

A thin layer, in the context of the present invention, is understood to be a layer, the thickness of which is between 5 and 500 μm, in particular 10 to 400 μm, or even 20 and 300 μm, or even between 50 and 250 μm. This thickness may vary depending on the viscosity and composition of the composition, the nature of the substrate and the number of applications on said substrate.

The expression “solid composition” is understood here to mean, as opposed to a “liquid composition”, a composition that does not flow under the effect of its own weight and is not deformable by the effect of its own weight; a solid composition can thus be semi-rigid or flexible. On the contrary, a “liquid composition” (or fluid) is a composition that can flow under its own weight, be poured, transferred. A liquid (or fluid) composition corresponds, in the context of the present invention, to a paint or ink composition, for example.

The method according to the invention is also characterized in that the solid composition is secured to a substrate, in particular in the form of a thin layer that adheres to said substrate on which it has been applied and has hardened.

According to a particular embodiment, the substrate is made of a material selected from the group comprising glass, textile, paper, cardboard, plastic, brick, metal and ceramic.

The term “substrate” is understood herein to mean any material element that is totally or partially coated with the solid composition according to the invention.

A substrate may comprise or consist of a continuous surface that is more or less extended and more or less flat, such as an opaque or transparent barrier, for example a wall, floor or glazed area such as a window.

A substrate can also comprise an article, that is, a discrete or individualized object, the surface of which will be coated, in whole or in part, with the solid composition according to the invention.

The invention thus relates to an article comprising a solid composition according to the invention.

The article according to the invention may be made of glass, textile, paper, cardboard, plastic, brick, metal or ceramic.

An article according to the invention may be in the form of a mat, a cushion, a basket, a cover, a collar, a harness, a saddle, a toy, a ball, a balloon, a stuffed toy, a rope, a ring, a trunk, a tower, for example.

According to an advantageous embodiment, when the solid composition comprising a polymeric resin further comprises at least one acrylic block copolymer, the method according to the invention is characterized in that the acrylic block copolymer is a bi-block copolymer or a tri-block copolymer.

More particularly, the tri-block copolymer comprises at most two identical blocks.

Advantageously, the alkyl polymethacrylate is polymethyl methacrylate (PMMA).

Also advantageously, the alkyl polyacrylate is selected from the group consisting of poly butyl acrylate (PABu) and a copolymer of butyl acrylate and 2-ethylhexyl acrylate.

More particularly, the acrylic block copolymer is a tri-block copolymer of the PMMA-PABu-PMMA type.

In the context of the present invention, the expression “block polymer” represents a polymer whose macromolecules are composed of linearly linked blocks. The blocks can be assembled directly or by means of a constituent unit that is not an integral part of the blocks.

In the context of the present invention, the expression “block copolymer” represents a block copolymer derived from several polymer species.

In the context of the present invention, the expression “block” represents the part of a macromolecule comprising a plurality of constituent units and that has at least one feature of its constitution or configuration that does not appear in the adjacent parts.

The expression “semiochemical substance” qualifies a chemical substance emitted by a plant or an animal in the environment and that has a signal value between living beings.

The expression “composition comprising a semiochemical substance” refers to a composition, typically a liquid composition that comprises, or consists of, one or more semiochemical substances, optionally solubilized in a solvent.

Semiochemical substances are classified into pheromones—that enable communication between individuals of the same species—and allomones, kairomones and synomones that are exchanged between animals or plants belonging to different species. Semiochemical substances may be perceived by smelling for volatile compounds, or by tasting for non-volatile compounds. The information carried by the semiochemicals can enable the locating and recognition of a sexual partner, for example.

Semiochemical substances and more particularly pheromones are chemical compounds of which a large number of examples (8,000) is given in the database accessible online, Pherobase (www.pherobase.com).

According to one embodiment of the invention, the semiochemical substance is a volatile semiochemical substance, in particular a volatile semiochemical substance with a fatty chain, and is advantageously selected from the group of pheromones.

In a particularly preferred way, the volatile semiochemical substance is lipophilic and is a fatty-chain pheromone.

The expression “fatty chain” is understood to mean, within the meaning of the present invention, a linear or branched hydrocarbon-based aliphatic chain, optionally unsaturated, comprising 5 to 18, 6 to 16 or 5 to 16 carbon atoms, thus conferring a lipophilic character to the semiochemical substance.

The expression “volatile” refers to the high volatility of the semiochemical substance that can easily pass from the liquid state to the gaseous state, under ambient pressure and temperature conditions, that is, approximately 20° C. and 760 mm Hg. “Volatile” liquid being a liquid whose saturated vapor pressure at 20° C. is greater than 0.01 mm Hg, preferentially it is between 0.01 and 20, in a more preferential way between 0.01 and 10, more preferentially between 0.0 and 5.

Among the examples of fatty-chain pheromones, pheromones known and usable according to the present invention are: volatile alkanols and alkenols having from 5 to 18 carbons, volatile alkanals and alkenals having from 5 to 18 carbons, alkanones having from 6 to 18 carbons, 1,7-dioxaspirononane, 3-or 4-hydroxy-1,7-dioxaspiro-undecane, benzyl alcohol, z-(9)-tricosene (muscature), heneicosene, diacetyl or alkanoic acids having 5 to 16 carbons such as caprylic acid, lauryl acid, pinene, methyl-eugenol and ethyldodecanoate, tert-butyl 4-(or 5-)chloro-2-ethylcyclohexane-carboxylate, mycrenone, cucurbitacin, trimedlure 15 and (E,E)-8,10-dodecadien-1-ol (codlemone).

Advantageously, the volatile semiochemical substance may be chosen from among ferruginol, ferrugineone or a ferruginol-ferrugineone mixture.

Other examples of known fatty-chain pheromones are: Z-5-Decenyl acetate, dodecanyl acetate, Z-7-dodecenyl acetate, E-7-dodecenyl acetate, Z-8-dodecenyl acetate, E-8-dodecenyl acetate, Z-9-dodecenyl acetate, E-9-dodecenyl acetate, E-10-dodecenyl acetate, 11-dodecenyl acetate, Z-9,11-dodecadienyl acetate, E-9,11-dodecadienyl acetate, Z-11-tridecenyl acetate, E-11-tridecenyl acetate, tetradecenyl acetate, E-7-tetradecenyl acetate, Z-8-tetradecenyl acetate, E-8-tetradacenyl acetate, Z-9-tetradecenyl acetate, E-9-tetradecenyl acetate, Z-10-tetradecenyl acetate, E-10-tetradecenyl acetate, Z-11-tetradecenyl acetate, E-11-tetradecenyl acetate, Z-12-pentadecenyl acetate, E-12-pentadecenyl acetate, hexadecanyl acetate, Z-7-hexadecenyl acetate, Z-11-hexadecenyl acetate, E-11-hexadecenyl acetate, octadecanyl acetate, E,Z-7,9-dodecadienyl acetate, Z,E-7,9-dodecadienyl acetate, E,E-7,9-dodecadienyl acetate, Z,Z-7,9-dodecadienyl acetate, E,E-8,10-dodecadienyl acetate, E,Z-9,12-dodecadienyl acetate, E,Z-4,7-tri-decadienyl acetate, 4-methoxy-cinnamaldehyde, [beta]-ionone, estragol, eugenol, indole, 8-methyl-2-decyl propanoate, E,E-9,11-tetradecadienyl acetate, Z,Z-9,12-tetradecadienyl acetate, Z,Z-7,11-hexadecadienyl acetate, E,Z-7,11-hexadecadienyl acetate, Z,E-7,11-hexadecadienyl acetate, E,E-7, 11-hexadecadienyl acetate, Z,Z-11,13-hexadecadienyl acetate Y,Z-11,13-hexadecadienyl acetate, Z,E-3,13-octadecadienyl acetate, E,Z-3,13-octadecadienyl acetate, E,E-3,13-octadecadienyl acetate, hexanol, heptanol, octanol, decanol, Z-6-nonenol, E-6-nonenol, 4methyl 5nonanol, 4 methyl 5 nonanone, dodecanol, 11-dodecenol, Z-7-dodecenol, E-7-dodecenol, Z-8-dodecenol, E-8-dodecenol, E-9-dodecenol, Z-9-dodecenol, E-9,11-dodecadienol, Z-9,11-dodecadienol, Z,E-5,7-dodecadienol, E,E-5,7-dodecadienol, E,E-8,10-dodecadienol, E,Z-8,10-dodecadienol, Z,Z-8,10-dodecadienol, Z,E-8,10-dodecadienol, E,Z-7,9-dodecadienol, Z,Z-7,9-dodecadienol, E-5-tetradecenol, Z-8-tetradecenol, Z-9-tetradecenol, E-9-tetradecenol, Z-10-tetradecenol, Z-11-tetradecenol, E-11-tetradecenol, Z-11-hexadecenol, Z,E-9, 11-tetradecadienol, Z,E-9,12-tetradecadienol, Z,Z-9,12-tetradecadienol, Z,Z-10,12-tetradecadienol, Z,Z-7,11-hexadecadienol, Z,E-7,11-hexadecadienol, (E)-14-methyl-8-hexadecen-1-ol, (Z)-14-methyl-8-hexadecen-1-ol, E,E-10,12-hexadecadienol, E,Z-10,12-hexadecadienol, dodecanal, Z-9-dodecenal, tetradecanal, Z-7-tetradecenal, Z-9-tetradecenal, Z-11-tetradecenal, E-11-tetradecenal, E-11,13-tetradecadienal, E,E-8,10-tetradecadienal, Z,E-9,11-tetradecadienal, Z,E-9,12-tetradecadienal, hexadecanal, Z-8-hexadecenal, Z-9-hexadecenal, Z-10-hexadecenal, E-10-hexadecenal, Z-11-hexadecenal, E-11-hexadecenal, Z-12-hexadecenal, Z-13-hexadecenal, (Z)-14-methyl-8-hexadecenal, (E)-14-methyl-8-hexadecenal, Z,Z-7,11-hexadecadienal, Z,E-7,11-hexadecadienal, Z,E-9, 11-hexadecadienal, E,E-10, 12-hexadecadienal, E,Z-10, 12-hexadecadienal, Z,E-10,12-hexadecadienal, Z,Z-10,12-hexadecadienal, Z,Z-11, 13-hexadecadienal, octadecanal, Z-11-octadecenal, E-13-octadecenal, Z-13-octadecenal, Z-5-decenyl-3-methyl butanoate, disparlure: (+) cis-7,8-epoxy-2-methyloctadecane, suedenol: 3-methyl-2-cyclohexen-1-ol, sulcatol: 6-methyl-5-hepten-2-ol, ipsenol: 2-methyl-6-methylene-7-octen-4-ol, ipsdienol: 2-methyl-6-methylene-2,7-octadien-4-ol, grandiure I: cis-2-isopropenyl-1-methylcyclobutane-ethanol, grandiure II: Z-3,3-dimethyl-1-cyclohexane-ethanol, grandiure III: Z-3,3-dimethyl-1-cyclohexane-acataldehyde, grandiure IV: E-3,3-dimethyl-1-cyclohexane-acetaldehyde, cis-2-ver-benol: cis-4,6,6-trimethylbicyclo [3,1,1]hept-3-en-2-ol, cucurbitacin, 2-methyl-3-buten-2-ol, 4-methyl-3-heptanol, cucurbitacin, 2-methyl-3-buten-2-ol, 4-methyl-3-heptanol, [alpha]-pinene: 2,6,6-trimethylbicyclo[3,1,1]hepten-2-ene, [alpha]-caryophyllene: 4,11,11-trimethyl-8-methylene-bicyclo[7,2,0]undecane, Z-9-tricosene, [alpha]-multistriatin, 2-(2-endo, 4-endo)-5-ethyl-2,4-dimethyl-8-dioxabicyclo [3,2,1] octane, methyleugenol: 1,2-dimethoxy-4-(2-propenyl)phenol, lineatin: 3,3,7-trimethyl-2,9-dioxatricyclo [3,3,1,0] nonane, chalcogran: 2-ethyl-1,6-dioxaspiro[4,4]nonane, frontalin: 1,5-dimethyl-8-dioxabicyclo [3,2,1] octane, endo-brevicomin: endo-7-ethyl-5-methyl-6,8-15 dioxabicyclo[3,2,1]octane, exo-brevicomin: exo-7-ethyl-5-methyl-6,8-dioxabicyclo[3,2,1]octane, (Z)-5-(1-decenyl)dihydro-2-(3H)-furanone, farnesol: 3,7,11-trimethyl-2,6,10-dodecatrien-1-ol, nerolidol 3,7-11-trimethyl-1,6,10-dodecatrien-3-ol, 3-methyl,6-(1-methylethenyl)-9-decen-1-ol acetate, (Z)-3-methyl-6-(1-methylethenyl)-3,9-decadien-1-ol acetate, (E)-3,9-methyl-6-(1-methyl-ethenyl)-5,8-decadien-1-ol acetate, 3-methylene-7-methyl-octen-1-ol propionate, (Z)-3,7-dimethyl-2,7-octadien-1-ol propionate, (Z)-3,9-dimethyl-6-(1-methyl-ethenyl)-3,9-decadlien-1-ol.

In another embodiment of the present invention, the volatile semiochemical substance is an animal pheromone, in particular a mammalian pheromone.

The mammals according to the invention are preferably selected from dogs, cats, horses, cattle and pigs.

The animal pheromone, in particular from mammals, can thus be selected from pheromones of dogs, cats, horses, cattle and pigs.

Preferentially, the animal pheromone is an appeasing pheromone.

In a preferential way, the mammalian pheromones are appeasing pheromones such as apaisine, which is secreted by females during lactation or facial pheromones in cats.

Among animal pheromones, social regulation pheromones such as urine markers or feline interdigital pheromones to mark their territory can also be distinguished. The pheromones according to the invention are natural or synthetic pheromones.

In a particular embodiment of the invention, the semiochemical substance may be protected against the action of light and/or oxygen. Indeed, when the diffusing articles according to the invention are used in cultures for several months, it may be preferable to protect the semiochemical substance from alteration over time. The skilled person will usually add antioxidants and UV stabilizers to the semiochemical substances to fulfill this function. One advantage of the method according to the invention is that the UV stabilizers or antioxidants may already be contained in the liquid composition before it is applied to a substrate or its impregnation by the semiochemical compound or are added to the composition comprising the semiochemical substance before the latter is incorporated/adsorbed in/by the polymeric composition. These two methods ensure intimate protection of the semiochemical substance until it is diffused into the external environment.

The antioxidants may be chosen from the group consisting of vitamin E, butylated hydroxyanisole (BHA), butylated hydroxytoluene (BHT) used alone or in a mixture. These antioxidants protect the semiochemical substance from degradation and may be added in amounts, as a percentage by weight of the liquid or solid composition, ranging from about 0.1% to about 3%, particularly between 0.5 and 2%.

The anti-UV additives may be selected from the group consisting of beta-carotene, p-aminobenzoic acid, hindered amines and hindered alkoxyamines used alone or in a mixture. These anti-UVs protect the semiochemical from degradation by light and can be added in amounts, in percentage by weight of the composition, ranging from about 0.1% to about 3%, particularly between 0.5 and 2%.

As mentioned, the method according to the invention is characterized in that the pheromone is an animal pheromone, in particular an appeasing pheromone from mammals.

Thus, according to an advantageous embodiment of the invention, the method is characterized in that the step d.) of diffusing said semiochemical substance from the impregnated solid composition is carried out at the living area of an animal and that the method enables the appeasement of the animal. As such, the solid composition according to the invention can be applied on a substrate selected from the group comprising a mat, a cushion, a basket, a cover, a transport case, a pet house, a barrier, for example.

In addition, according to one embodiment of the invention, the substrate on which the liquid composition according to the invention is applied comprises an article that is in contact with the animal or used by the animal. Thus, a substrate of the composition according to the invention can be selected from the group comprising a collar, a harness, a jacket, a mantle, a saddle, or a cover, for example.

The substrate of the solid composition may also comprise an article with which the animal interacts and the substrate is then selected from the group comprising a toy, ball, balloon, stuffed toy, rope, ring, cat tree, trunk, tower, for example.

The present invention also relates to a liquid composition comprising at least one polymeric resin, at least one solvent, optionally at least one pigment, optionally at least one filler, optionally at least one semiochemical substance and at least one acrylic block copolymer, said acrylic block copolymer comprising at least one alkyl polymethacrylate block and at least one alkyl polyacrylate block.

Such a liquid composition is thus in the form of a paint or ink composition for a surface coating that enables the coating of a substrate.

“Coating” means here that the liquid composition is applied to a solid substrate that will be partially or totally coated with the liquid composition that will be solidified following the evaporation of the solvent and will form the solid composition.

Another advantage of the composition according to the invention is in fact that it can be applied to any object form.

Indeed, its liquid (or fluid) nature makes it possible to apply it to any surface and to cover all or part of a given substrate. Thus it is possible to apply it to a solid or flexible substrate such as a collar, a fabric, a stake, a bar, a plate or a sign made of any material for example, in connection with the mode of use and the site of diffusion that is envisaged.

The application can carried out with a roller, with a brush, by spraying, by dipping or by any other suitable means making it possible to coat the substrate in whole or in part by the fluid composition.

The ease of application of the liquid composition according to the invention also makes it possible to use it as a paint or an ink and to produce any application on any substrate, in particular a textile, in order to cover it totally or partly, even by defining logos or inscriptions, depending on the wishes or desires of the user.

Thus, the liquid composition according to the invention can be used in a printing method by screen printing techniques known to a person skilled in the art, in order to screen print any substrate of their choice, regardless of the material, for example on clothing, toys or any utensil for example.

The liquid composition then solidifies via solvent evaporation, which makes it possible to obtain a solid composition in the form of a surface coating comprising, or consisting of, a continuous phase of polymeric resin wherein the optional pigment is dispersed, the optional filler, the at least one optional acrylic block copolymer, said acrylic block copolymer comprising at least one alkyl polymethacrylate block and at least one alkyl polyacrylate block, as well as the optional semiochemical substance.

The liquid composition according to the invention is also characterized in that the semiochemical substance represents between 0% and 80% by weight of the liquid composition, particularly between 1 and 60%, even more particularly between 5 and 50%.

The substrates coated with the solid composition according to the invention, if it does not already contain the semiochemical compound, can then be impregnated and loaded with a composition comprising a semiochemical substance.

This impregnation, or loading, can be carried out by simply bringing the solid composition according to the invention into contact with a composition comprising a semiochemical compound. In particular, the composition comprising said semiochemical compound is in the form of a liquid composition comprising said semiochemical compound and that is brought into contact with the solid composition.

Such bringing into contact can be carried out by vaporizing a liquid composition comprising the semiochemical compound, but also by coating with a brush or a roller or by dipping, for example.

It is obvious that given the prices of the semiochemical substances, an application that makes it possible to limit losses and thus an application by spraying will be preferred, atomization will be more advantageous.

Another particularly important advantage of the composition according to the invention is that the solid composition can be loaded and/or reloaded by a semiochemical substance, such as a pheromone.

Indeed, once the initial amount of semiochemical compound, absorbed by the solid composition—or initially present in the liquid composition—has been released and diffused, it is possible to recover the solid composition or the substrate coated with the solid composition according to the invention (and this regardless of its form) and to re-impregnate said semiochemical composition according to the method described above. Likewise, a wall covered by the solid composition according to the invention may be re-impregnated with a composition comprising a semiochemical substance by contacting as explained above.

Thus, it is also an aim of the invention to provide a method for manufacturing a solid composition according to the invention loaded with a semiochemical substance, comprising the following steps:
providing a solid composition comprising a polymeric resin constituting a continuous phase wherein there is dispersed and immobilized at least one acrylic block copolymer comprising at least one alkyl polymethacrylate block and at least one alkyl polyacrylate block, an optional filler and an optional pigment;
contacting said composition with a composition comprising a semiochemical substance for a time and at a temperature allowing the impregnation of said solid composition by said substance,
recovering said solid composition impregnated with a semiochemical substance.

The solid composition according to the invention is also characterized in that once impregnated with the semiochemical substance, it represents between 1% and 80% by weight of the solid composition, particularly between 1 and 50%, between 5 and 50%, even more particularly between 5 and 40%, or even between 5 and 30%, or even between 5 and 20%.

A solid composition according to the invention can thus diffuse and gradually release the semiochemical substance in the environment until the amount of organic substance contained is exhausted. It can then be reused for a reload as described above, then a new diffusion. And this can be repeated several times.

Such an advantage is very important since it makes it possible to recycle the substrates coated with the solid composition, which is economically and ecologically sound.

The inventors have noticed that a solid composition made of polymeric resin as described above had the ability to absorb and release a semiochemical substance. The addition of acrylic block copolymers makes it possible to improve this property in a way that is significant but not essential to obtain the technical effect of impregnation/absorption and release.

The acrylic block copolymer comprising at least one alkyl polymethacrylate block and at least one alkyl polyacrylate block is dispersed within the continuous resin phase in the form of inclusions that will contribute to capturing, absorbing, retaining and releasing the semiochemical substance.

The invention thus relates to a solid composition according to the invention, characterized in that the polymeric resin constitutes a continuous phase wherein there is dispersed and immobilized the at least one acrylic block copolymer comprising at least one alkyl polymethacrylate block and at least one alkyl polyacrylate block, the optional filler and the optional pigment.

Finally, the invention finally relates to the use of a solid or liquid composition according to the invention comprising at least one semiochemical substance for the diffusion of said semiochemical substance.

The invention finally relates to the use of a solid or liquid composition according to the invention for the absorption and the diffusion of a semiochemical substance.

### EXAMPLES

### Materials and Raw Materials

The block copolymer materials are materials from the nanostrenth® line sold by Arkema, for example M53, M65 or M53F. The pheromones are synthesized by M2i Development or M2i Salin according to methods already reported in the literature. The pheromone of the Lobesia Botrana (European grapevine moth) is 7E,9Z-dodecadienylacetate (CAS: 54364-62-4) of molar mass 224.34 g/mol. Methyl laurate (CAS 111-82-0) with molar mass 214.34 g/mol is one of the components of the FELIWAY appeasing pheromonal composition. The commercial inks are purchased from TIFLEX.

Example 1: Demonstration of the retention effect on films of block copolymers:

A block copolymer solution M53 in ethyl acetate is prepared at 20% by weight. By means of a glass pipette, 10 mL of solution are deposited in an aluminum tray 10 cm in diameter. The tray is placed in a ventilated oven for 24 hours. A homogenous block copolymer film is obtained. 10 trays are thus prepared and numbered from 1 to 20.

100 mg of pheromone of lobesia (7E,9Z-dodecadienylacetate) are deposited on the trays numbered from 1 to 5. 100 mg of methyl laurate is deposited on those numbered from 6 to 10. The two active agents are applied to the film by means of a spray of pheromone solution diluted to 20% in pentane. The trays are left in open air until the active ingredient disappears. The trays are deposited in a ventilated oven maintained at 40° C. (lobesia) or 30° C. (methyl laurate). Two blank trays are loaded with the same amount of each active agent.

The trays are regularly analyzed to determine the level of residual pheromone (by simple weighing or preferentially by gas chromatography).

In Table 1 below, the diffusion time in the oven necessary to arrive below 10% residual active agent is reported relative to the quantity introduced.

TABLE 1

| | Unladen | | | | | | | | | | |
|---|---|---|---|---|---|---|---|---|---|---|---|
| | tray | | | | | | | | | | |
| | (reference) | 1 | 2 | 3 | 4 | 5 | 6 | 7 | 8 | 9 | 10 |
| Lobesia | 72 h | — | — | — | — | — | 720 h | 696 h | 744 h | 720 h | 672 h |
| (% res) | | | | | | | | | | | |
| Methyl | 24 h | 240 h | 264 h | 226 h | 240 h | 240 h | — | — | — | — | — |
| laurate | | | | | | | | | | | |
| (% res) | | | | | | | | | | | |

This example shows the retention effect of a surface treated by block copolymer film deposition relative to an untreated surface.

Example 2: Demonstration of the effect of the copoblock by comparing an ink without added block copolymers to an ink with such additive.

Square glass plates with 10 cm sides are printed by conventional screen printing with two commercial blue inks of the polyworks (TIFLEX) and vinyl (TIFLEX) types. A series of plates is used without treatment, while the other series is treated with a spray of a 10% solution of M53 block copolymers without ethyl acetate. Once dried, these plates are not visually different from the untreated plates.

In the four series of plates, lobesia pheromone and methyl laurate in 20% solution in pentane are sprayed. The plates are left in air and then left to diffuse in a ventilated oven at 30° C. and 40° C. for the plates impregnated with lobesia and the plates impregnated with methyl laurate, respectively. The trays are regularly analyzed to determine the level of residual pheromone (by simple weighing or preferentially by gas chromatography).

In Table 2 below, the diffusion time in the oven necessary to arrive below 10% residual active agent is reported relative to the quantity introduced.

TABLE 2

| | | Polyworks ink | | | | Vinyl ink | | | |
|---|---|---|---|---|---|---|---|---|---|
| | Unladen | Without | With | Without | With | Without | With | Without | With |
| | tray | copoblock | copoblock | copoblock | copoblock | copoblock | copoblock | copoblock | copoblock |
| | (reference) | additive | additive | additive | additive | additive | additive | additive | additive 8 |
| Lobesia | 72 h | 72 h | 168 h | — | — | 72 h | 168 h | — | — |
| (% res) | | | | | | | | | |
| Methyl | 24 h | — | — | 24 h | 96 h | — | — | 24 h | 96 h |
| laurate | | | | | | | | | |
| (% res) | | | | | | | | | |

This example shows the retention effect of an ink-coated surface and with added block copolymer with respect to an untreated surface and an ink-coated surface.

1. A method for diffusing a semiochemical substance comprising the following steps:
a. providing a solid composition comprising a polymeric resin, an optional filler and an optional pigment,
b. Bringing a composition comprising a semiochemical substance into contact with the solid composition,
c. Impregnating the solid composition with the composition comprising the semiochemical sub stance,
d. Diffusing said semiochemical substance from the solid composition,
e. optionally repeating steps b to d, characterized in that the solid composition comprising a polymeric resin further comprises at least one acrylic block copolymer, said acrylic block copolymer comprising at least one alkyl polymethacrylate block and at least one alkyl polyacrylate block; said copolymer being dispersed and immobilized in the polymeric resin, characterized in that step a) is preceded by steps α1) to α3); step α1) comprising providing a liquid composition comprising at least one polymeric resin, at least one solvent, optionally at least one pigment, optionally at least one filler and at least one acrylic block copolymer, said acrylic block copolymer comprising at least one alkyl polymethacrylate block and at least one alkyl polyacrylate block; step α2) comprising applying the liquid composition on a substrate and step α3) comprising evaporating the solvent.

2. The method according to claim 1, characterized in that the solid composition is secured to a substrate, in particular in the form of a thin layer.

3. The method according to claim 2, characterized in that the substrate is made of a material selected from the group comprising glass, textile, paper, cardboard, plastic, metal and ceramic.

4. The method according to claim 1, characterized in that the acrylic block copolymer is a bi-block copolymer or a tri-block copolymer.

5. The method according to claim 1, characterized in that the tri-block copolymer comprises at most 2 identical blocks.

6. The method according to claim 1, characterized in that the alkyl polymethacrylate is polymethyl methacrylate (PMMA).

7. The method according to claim 1, characterized in that the alkyl polyacrylate is selected from the group consisting of poly butyl acrylate (PABu) and a copolymer of butyl acrylate and 2-ethylhexyl acrylate.

8. The method according to claim 1, characterized in that the acrylic block copolymer is a tri-block copolymer of the PMMA-PABu-PMMA type.

9. The method according to claim 1, characterized in that the semiochemical substance is an animal pheromone.

10. The method according to claim 9, characterized in that the animal pheromone is selected from pheromones of dogs, cats, horses, cattle and pigs.

11. The method according to claim 9, characterized in that the animal pheromone is an appeasing pheromone.

12. The method according to claim 9, characterized in that step d) of diffusion of said semiochemical substance from the impregnated solid composition is carried out at the living area of an animal.

13. The method according to claim 12, characterized in that the solid composition according to the invention is applied on a substrate selected from the group comprising a mat, a cushion, a basket, a cover, a transport case, a pet house, a barrier, a collar, a harness, a jacket, a mantle, a saddle.

14. A liquid composition comprising at least one polymeric resin, at least one solvent, optionally at least one pigment, optionally at least one filler, optionally at least one semiochemical substance and at least one acrylic block copolymer, said acrylic block copolymer comprising at least one alkyl polymethacrylate block and at least one alkyl polyacrylate block, characterized in that the polymeric resin is selected from the group comprising cellulosic resins, vinyl resins and polyurethane, mono or bicomponent resins.

15. The composition according to claim 14, characterized in that said composition is hardened or solidified and the polymeric resin constitutes a continuous phase wherein there is dispersed and immobilized the at least one acrylic block copolymer comprising at least one alkyl polymethacrylate block and at least one alkyl polyacrylate block, the optional filler and the optional pigment.

16. An article comprising a solid composition according to claim 15.

17. The article according to claim 16, characterized in that the surface of the article is coated in whole or in part by the solid composition.

18. The article according to claim 16, characterized in that it is made of glass, textile, paper, cardboard, plastic, brick, metal or ceramic.

19. The article according to claim 16, characterized in that it is in the form of a mat, a cushion, a basket, a cover, a collar, a harness, a saddle, a toy, a ball, a balloon, a stuffed toy, a rope, a ring, a trunk, a tower.

20. The use of a composition according to claim 14, comprising at least one semiochemical substance for the diffusion of said semiochemical substance.

21. The use of a composition according claim 14, for the absorption and the diffusion of a semiochemical substance.
